(19) United States
(12) Patent Application Publication
(10) Pub. No.: US 2016/0165865 A1
(43) Pub. Date: Jun. 16, 2016

(54) TREATED FABRIC USED FOR FISHING

(71) Applicant: George P. Korteweg, Mystic, CT (US)

(72) Inventor: George P. Korteweg, Mystic, CT (US)

(21) Appl. No.: 14/966,639

(22) Filed: Dec. 11, 2015

Related U.S. Application Data
(60) Provisional application No. 62/091,185, filed on Dec. 12, 2014.

(51) Int. Cl. A01K 85/01; A01K 85/18

(52) U.S. Cl. CPC A01K 85/01; A01K 85/18

(57) ABSTRACT

A fish attractant material is provided. The fish attractant includes a fibrous material and a coating. The coating includes a polymer combined with a solvent. The coating is embedded and attached within the fibrous material. A coloring or a glow powder may be added to the coating to add additional effect. Multi-colors can be created, such as striping or the like, by double coating or by adding colors prior to drying.

### CROSS-REFERENCE TO RELATED APPLICATION

This application claims the benefit of priority of U.S. provisional application number 62/091,185, filed Dec. 12, 2014, the contents of which are herein incorporated by reference.

### BACKGROUND OF THE INVENTION

The present invention relates to fishing and, more particularly, to a specially treated material for attracting fish.

A fishing lure is a type of artificial fishing bait which is designed to attract a fish's attention. The lure uses movement, vibration, flash and color to bait fish. Many lures are equipped with one or more hooks that are used to catch fish when they strike the lure. Most lures are attached to the end of a fishing line and have various styles of hooks attached to the body and are designed to elicit a strike resulting in a hookset. Color and scent may also increase the chances the catching a fish.

As can be seen, there is a need for improved fishing lures that have a strong scent and color to attract fish.

### SUMMARY OF THE INVENTION

In one aspect of the present invention, a fish attractant comprises: a fibrous material; and a coating comprising a polymer and a solvent.

In another aspect of the present invention, a fish attractant comprises: a fibrous material; and a coating embedded within the fibrous material, wherein the coating comprises a thermoplastic elastomer combined with an aromatic hydrocarbon.

In another aspect of the present invention, a method of forming a fish attractant comprises: mixing a polymer with a solvent forming a coating; dipping a fibrous material into the coating, thereby allowing the coating to embed within the fibrous material; and drying the coating embedded within the fibrous material.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention in use;

FIG. 2 is a flow chart of process steps of an embodiment of the present invention;

FIG. 3 is a perspective view of an exemplary embodiment of the present invention;

FIG. 4 is a section view of an embodiment of the present invention, taken along line 4-4 in FIG. 3; and

FIG. 5 is a perspective view of embodiments of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a specially treated fabric used for fishing. The present invention may be considered a trailing scent gland. The trailing scent gland is designed from a chemically treated process which locks in scent, color and fish oils. The present invention includes a mixture including a basic soft rubber added to a solvent and a fibrous material coated with the mixture.

The materials of the present invention may include, but are not limited to, cotton with a scrim, shammy, PVA, Dacron, polyester, etc. In the preparation of the coating solution, 20-80% of the elastomer may be used. In certain embodiments, 40% by volume of the elastomer when mixed with a 60% by volume of an aromatic hydrocarbon solvent provides ideal properties. Once the coating has been prepared, the solution turns into a gel after several days. One may need to adjust the solution to create a workable liquid solution viscosity. After adding various effects such as color, glow etc., the fibrous material is then placed in the liquid formula and dried. The micron-thick coating on each fiber allows the interstitial space to carry excess oil, while the elastomer also holds an absorbed amount of oil for a period of time. After the scent has been flushed out in the water, it can be replaced by patting the scent gland dry and adding several drops of fish oil, depending on the size of the design.

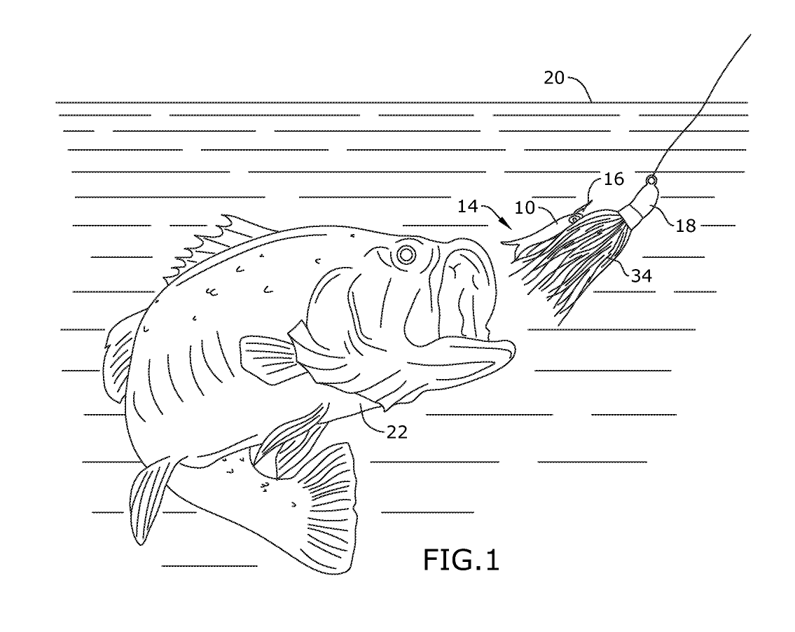

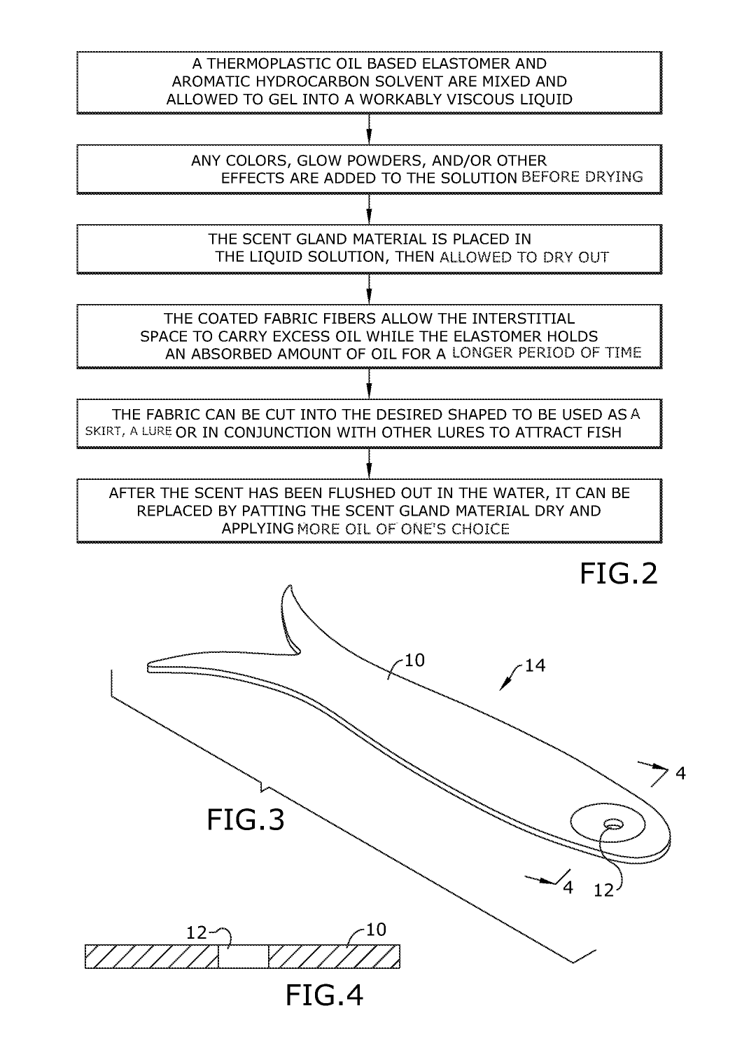

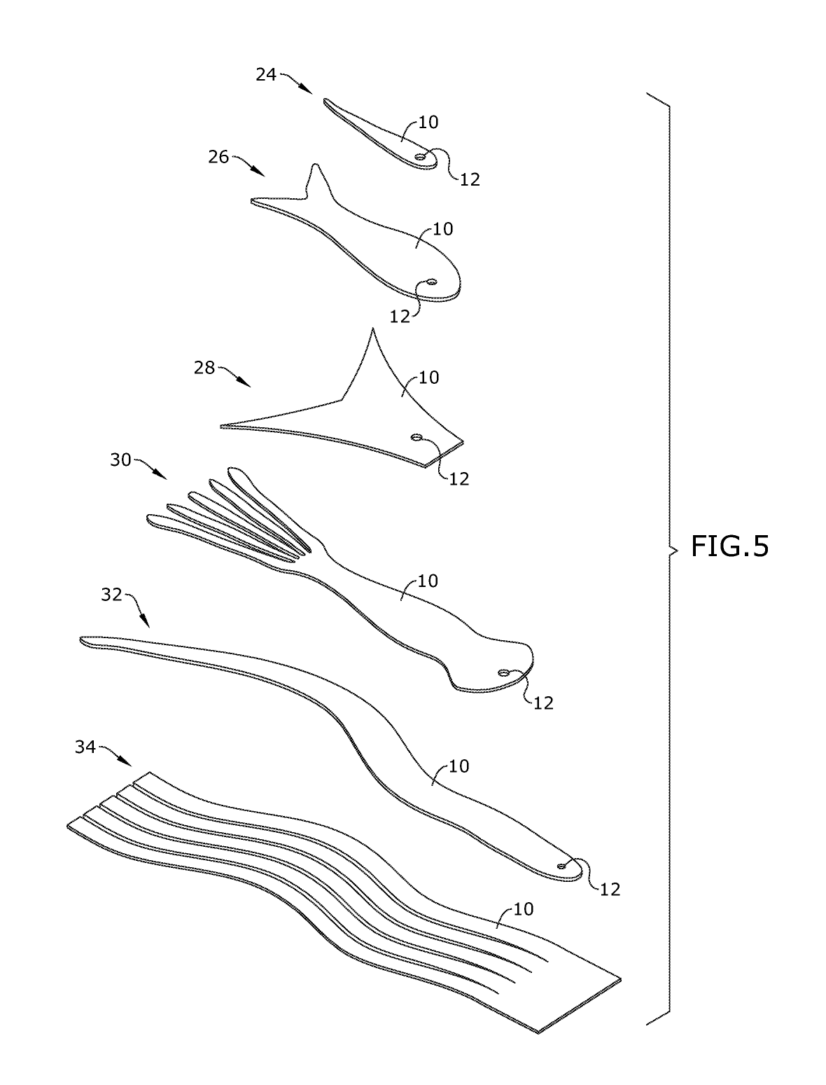

Referring to FIGS. 1 through 5, the present invention includes a fish attractant. The fish attractant includes a fibrous material 10 and a coating. The coating includes a polymer combined with a solvent. The coating is embedded within the fibrous material 10. A coloring or a glow material may be added to the coating to add additional effect.

The fibrous material 10 may include a cotton material, a leather material, a polyvinyl alcohol material, a polyethylene material, a polyester material, and the like. The fibrous material 10 may be in the shape of any marine animal 14, such as a fish 26, a fish tail 28 (to be attached to a fish-type lure), a tadpole 24, a squid 30, a skirt 34, an eel or worm 32, and the like. The fibrous material 10 may include a hook hole 12 formed through a first end. The hook hole 12 may be placed over and around a fishing hook 16, thereby attaching it to the fishing hook 16. The coated fibrous material 10 may be used in conjunction with a fishing lure 18, such as a fishing lure 18 with skirt material 34, also of the same material. The scent and color from the coated fibrous material 10 and skirt 34, in conjunction with the fishing lure 18 increases the likelihood of catching a fish 22.

In certain embodiments, the polymer is about 20% up to about 80% of the coating and the solvent is about 20% up to about 80% of the coating. For example, the polymer is about 40% of the coating and the solvent is about 60%.

The polymer of the present invention may include approximately a 0 shore A durometer to approximately a 65 shore A durometer. The polymer of the present invention may be a thermoset material, a thermoplastic material or a combination thereof. In certain embodiments, the polymer may be a thermoplastic elastomer, a urethane, a latex, a silicone or a combination thereof.

The solvent of the present invention may include an aromatic hydrocarbon.

The present invention may further include a method of forming a fish attractant. The method may include the following steps. A thermoplastic oil based elastomer and an aromatic hydrocarbon solvent are mixed and allowed to gel into a workably viscous liquid. Colors, glow powders, sparkles, and the like are added to the solution. The scent gland material, such as a fibrous material, is dipped into the liquid solution and then dried. The coated fabric fibers allow the interstitial space to carry excess oil while the elastomer holds an absorbed amount of oil for a longer period of time. The fabric may then be cut into a desired shape to be used as a skirt, a lure, or in conjunction with other lures to attract fish. After the applied scent has been flushed out in the water, the scent may be replaced by patting the scent gland material dry and applying more oil of one's choice. Many types of oils are available and will work with this scent gland by longer retention periods.

It should be understood, of course, that the foregoing relates to exemplary embodiments of the invention and that modifications may be made without departing from the spirit and scope of the invention as set forth in the following claims.

What is claimed is:

1. A fish attractant comprising:
a fibrous material; and
a coating comprising a polymer combined with a solvent.

2. The fish attractant of claim 1, wherein the fibrous material is at least one of a cotton material, a leather material, a polyvinyl alcohol material, a polyethylene terephthalate material, and a polyester material.

3. The fish attractant of claim 1, wherein the coating is embedded within the fibrous material.

4. The fish attractant of claim 1, wherein the polymer is a thermoplastic material.

5. The fish attractant of claim 1, wherein the polymer comprises at least one of a thermoplastic elastomer, a urethane, a latex, and a silicone.

6. The fish attractant of claim 1, wheiren the polymer comprises approximately a 0 shore A durometer to approximately 65 shore A durometer.

7. The fish attractant of claim 1, wherein the polymer is about 20% up to about 80% of the coating and the solvent is about 20% up to about 80% of the coating.

8. The fish attractant of claim 6, wherein the polymer is about 40% of the coating and the solvent is about 60% of the solvent.

9. The fish attractant of claim 1, wherein the solvent is an aromatic hydrocarbon.

10. The fish attractant of claim 8, wherein the aromatic hydrocarbon is a solvent with 99.9% dissipation.

11. The fish attractant of claim 1, wherein the coating further comprises at least one of a coloring and a colored material with a clear coating of solution.

12. A fish attractant comprising:
a fibrous material; and
a coating embedded within the fibrous material, wherein the coating comprises a thermoplastic elastomer combined with an aromatic hydrocarbon.

13. A method of forming a treated material comprising:
mixing a polymer with a solvent forming a solution;
dipping a fibrous material into the solution, thereby allowing the solution to embed within the fibrous material; and
drying the solution embedded within the fibrous material.

14. The method of claim 13, further comprising the step of adding at least one of a coloring, a glow material, and sparkles to the solution prior to dipping the fibrous material into the solution or prior to drying of the solution.

15. The method of claim 13, wherein the polymer is a thermoplastic elastomer and the solvent is an aromatic hydrocarbon.
